(19) United States
(12) Patent Application Publication
(10) Pub. No.: US 2004/0125126 A1
(43) Pub. Date: Jul. 1, 2004

(54) Video browsing system

(75) Inventors: Yutaka Egawa, Tokyo (JP); Eisuke Kanno, Tokyo (JP); Michitoshi Suzuki, Tokyo (JP); Shunsuke Nagatani, Tokyo (JP); Masakazu Ogawa, Tokyo (JP); Shinya Taguchi, Tokyo (JP)

Correspondence Address: OLIFF & BERRIDGE, PLC, P.O. Box 19928, Alexandria, VA, 22320, US

(73) Assignee: Fuji Xerox Co., Ltd., Minato-ku (JP)

(21) Appl. No.: 10/658,768

(22) Filed: Sep. 10, 2003

(30) Foreign Application Priority Data
Dec. 25, 2002 (JP) P2002-373769

(51) Int. Cl. G09G 5/00

(52) U.S. Cl. 345/716

(57) ABSTRACT

A distribution server distributes content including video data and slide data reproduced in synchronization with the video data, for a browsing client of a user having permission for browsing the content stored in a distribution server. The content is allowed to edit in accordance with an access of a provider client having a permission for editing the content. The permission for browsing the content and the permission for editing the content are designated by a management client.

### BACKGROUND OF THE INVENTION

1. Field of the Invention

The present invention relates to a system for browsing video data (moving picture data) with which slide data (still picture data) is correlated in order to be synchronously reproduced.

2. Description of the Related Art

A service wherein a distribution server distributes to browsing clients a variety of types of content, such as personal computers and mobile terminals, has been widely provided as a specified area service or a wide area service.

There are various kinds of content distribution systems, and as the network communication technique has been developed, content data, including video data, also have come to be distributed.

As an overview of a content distribution system, various types of content data are registered with a distribution server, and when a browsing client accesses the server and selects and requests desired content, the distribution server provides the pertinent content data for the browsing client, so that a user can obtain the content through the browsing client.

The types of video data to be distributed have been expanded to include a variety of entertainment materials, ranging from movies to educational data for lectures and visual presentations. Especially for education, for lectures and visual presentations given with supporting reference materials, not only video pictures (video data) but also still pictures (slide data) are provided for a browsing client. The simultaneous reproduction of these pictures is preferable, so that the information they provide can be fully employed to support study and to promote a better understanding of the content.

An explanation will now be given for a case in education wherein a lecturer, a teacher, presents a lecture for a group of users, the students in a class. In this example provided for the video browsing system, the lecturer and the number of users constituting the class for the lecture should be specifically limited, and the content of the lecture provided for the user group may be changed, depending on how its presentation has progressed over a period of several months.

For the use, such as for education, of lectures or presentations, for which the lecturer employs the content to give a lecture to a specific user group, the users that can attend the lecture and the lecturer who is to present the lecture must be designated for the video browsing system, so that when the system is used, reality is enhanced.

### SUMMARY OF THE INVENTION

In order to resolve the above problems, it is one objective of the present invention to manage, in accordance with a purpose, a system that provides for a user content that includes video data and slide data to be reproduced synchronously, and that manages the permissions of a person who accesses the content.

It is another objective of the present invention to employ a network technique for enhancing the reality of a lecture presented by a lecturer to a group of users.

Other objectives of the present invention will become apparent during the course of the following explanation, given while referring to accompanying drawings.

The present invention can be achieved by various modes, such as a video browsing system, a distribution server and a management client that together constitute the video browsing system, a program that these by using computer to implement the system, and a video browsing method.

According to the present invention, a distribution server, which distributes content that includes video data, and slide data to be synchronously reproduced, has a function for managing, for each of multiple sets of data content, browsing permissions and editing permissions. Further, in accordance with the access afforded the browsing client of a user having browsing permissions, the distribution server distributes pertinent content, and in accordance with the access afforded the client of a user having editing permissions, the client is permitted to edit the internally stored content.

In the configuration above, and in accordance with the browsing permissions, the permissions of users who are permitted to employ a browsing client to accept content are limited, and a closed browsing space, such as is the case in education or for a lecture for which access by the participants is limited, can be formed. In addition, in accordance with the editing permissions, content providers who perform editing, such as effecting a new registration or changing and deleting contents, can be limited and a lecturer can be set up in the browsing space.

Therefore, the contents provider can add, change or delete lecture video (video data) and reference material video (slide data) and prepare lecture space for users for whom browsing permissions have been provided. In this manner, lecture space can be afforded a group of users for which, for educational purposes, browsing permissions have been granted.

In the case above, upon an access by a client possessing manager permissions, the browsing permissions and the editing permissions are set for the distribution server.

With this configuration, management can be provided by a manager, via a network, of a space wherein a lecture for participants is presented by a lecturer.

Furthermore, according to the present invention, the distribution server may store, in correlation with a display of user and slide data, notational data in consonance with slide data entered for the browsing client by a user, and may provide the notational data upon the reception of a request from the browsing client of the user.

In the configuration above, when slide data for the reference material are employed several times during a lecture video, a user can make notes correlated with the video lecture presented for study by the user.

### BRIEF DESCRIPTION OF THE DRAWINGS

The above objects and advantages of the present invention will become more apparent by describing in detail preferred exemplary embodiment thereof with reference to the accompanying drawings, wherein:

FIG. 1 is a diagram showing a system configuration according to one embodiment of the present invention;

FIG. 2 is a diagram showing a data structure according to the embodiment;

FIGS. 3A and 3B are diagrams for explaining the relationship between video data and slide data according to the embodiment;

FIG. 4 is a diagram showing an example screen display for a browsing client according to the embodiment;

FIG. 5 is a diagram showing an example screen display for the browsing client according to the embodiment;

FIG. 6 is a diagram showing an example screen display for the browsing client according to the embodiment;

FIG. 7 is a diagram showing an example screen display for the browsing client according to the embodiment;

FIG. 8 is a diagram showing an example screen display for the browsing client according to the embodiment;

FIG. 9 is a diagram showing an example screen display for a management client according to the embodiment;

FIGS. 10A, 10B and 10B are diagrams showing an example screen display for the management client according to the embodiment;

FIGS. 11A and 11B are diagrams showing an example screen display for the management client according to the embodiment;

FIG. 12 is a diagram showing an example screen display for the management client according to the embodiment;

FIG. 13 is a diagram showing an example screen display for the management client according to the embodiment;

FIGS. 14A and 14B are diagrams showing an example screen display for the management client according to the embodiment; and

FIG. 15 is a diagram showing an example screen display for the management client according to the embodiment.

### DETAILED DESCRIPTION OF THE PREFERRED EMBODIMENTS

Referring now to the accompanying drawings, a description will be given in detail of a preferred embodiment of the invention.

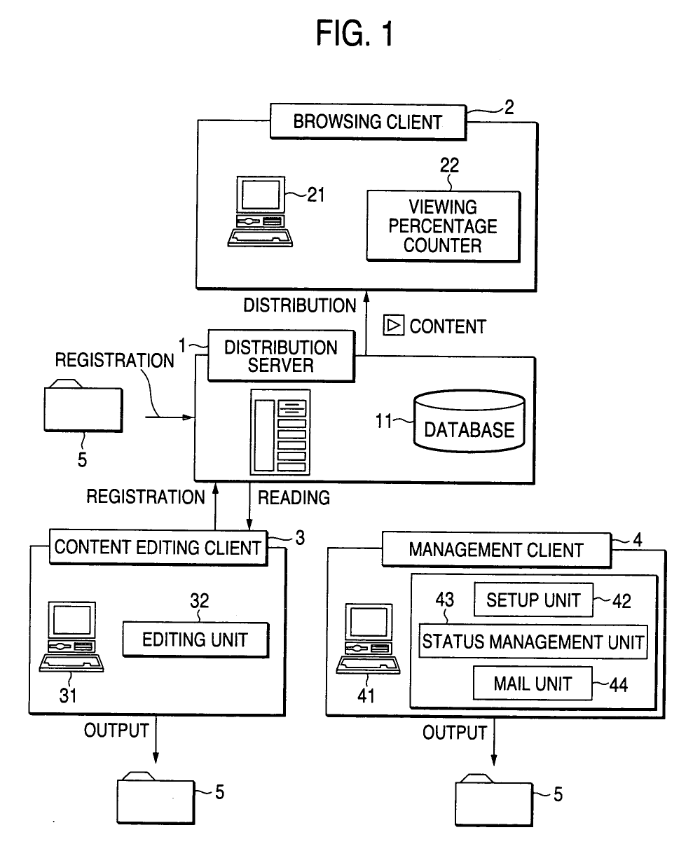

FIG. 1 is a diagram showing a video browsing system according to the present invention. The video browsing system includes a distribution server 1, a browsing client 2, an editing client 3 and a management client 4, all of which are connected through a computer network such as the Internet.

As needed, a plurality of browsing clients 2, editing clients 3 and management clients 4 may be provided.

The distribution server 1, the browsing client 2, the editing client 3 and the management client 4 execute a program in accordance with the present invention by using computer hardware, and may perform predetermined processing. For the browsing client 2, the editing client 3 and the management client 4, display devices 21, 31 and 41 are respectively provided that are constituted by personal computers having a content browsing function and a mail transmission/reception function.

The browsing client 2 includes a viewing percentage counter 22 that obtains, as a viewing percentage, the amount of video data browsed by the browsing client 2, i.e., the positions in the video whereat browsing was completed by the browsing client 2. The viewing percentage, which is retained by the browsing client 2, is also transmitted to the distribution server 1.

The editing client 3 has an editing unit 32 for accessing the distribution server 1 and editing the contents held thereby and managed by the distribution server 1. In the embodiment, the contents are registered as a form wherein video data and slide data therefor are collected as an archive file 5, and the contents that are held, and managed by the distribution server 1, are also output as the archive file 5 to the editing client 3 or the management client 4, so that the management and the transmission of the contents can be easily performed.

The management client 4 includes: a setup unit 42, for registering, with the distribution server 1, various data, such as browsing permissions for a user (a participant) and editing permissions for a contents provider (a lecture); a status management unit 43, for managing for each data group of content a lecture and the status of users who participated in the lecture; and a mail unit 44, for preparing and transmitting emails to registered users.

With these units, as will be described later, the management client 4 registers a user; designates the browsing permissions of the user for all content that has been set; obtains from the distribution server 1 an viewing percentage for the group of content for each user and displays the viewing percentage on a screen for a manager; and supports the preparation of email by the manager and the transmission of the email to users.

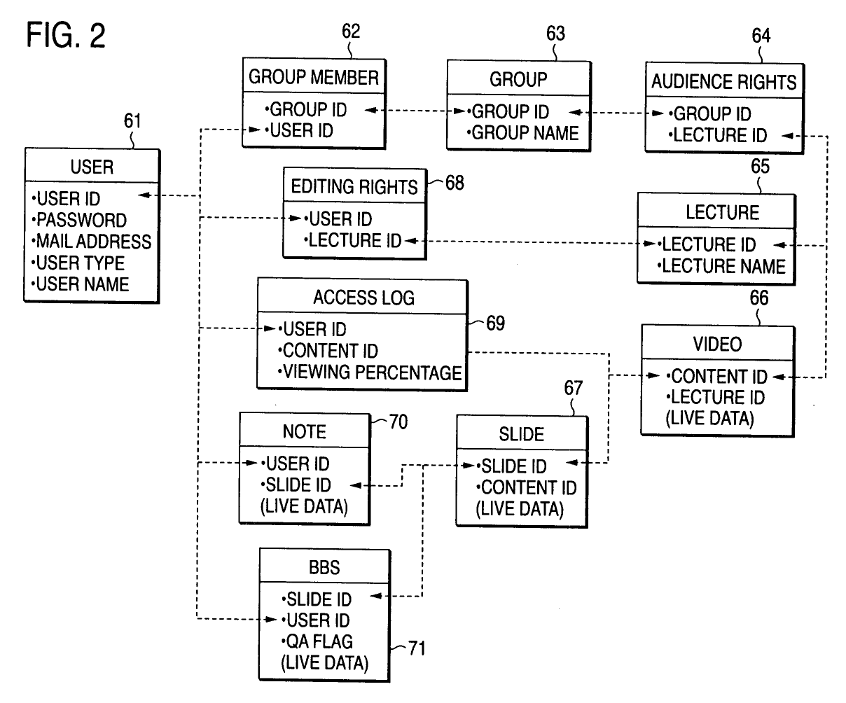

The distribution server 1 includes a database 11, on which data shown in FIG. 2 are stored and managed. Using the database 11, the distribution server 1 can implement a function for distributing the content, which includes video data and slide data that is to be synchronously reproduced, and a function for managing, for each group of content, browsing permissions and editing permissions for the content. When an access is effected by the browsing client 2 of a user for whom browsing permissions have been allocated, the distribution server 1 distributes the pertinent content, and when an excess is effected by the editing client 3 of the content provider having the editing permissions, the editing client 3 is permitted to edit the contents stored in the distribution server 1.

FIG. 2 is a diagram showing the managed data structures in the database 11 of the distribution server 1.

User data 61 includes a user ID, a password, a mail address, a user type and a user name for each user registered in the video browsing system. At the registration time, the user ID and the password are provided for a user by the management client (manager) 4; the mail address and the user name are designated by the management client (manager) 4 based on the application employed by the user; and the user type is set by the management client (manager) 4, as a common user who is also a browser, a user who is a lecturer or a manager.

Group member data 62 correlated with the user ID of the user data 61 includes a group ID and a user ID. In the embodiment, the user IDs of multiple users are correlated with the same group ID, so that the provision of permissions is managed by grouping the multiple users. Since the group member data 62 is set by the management client (manager) 4, the manager can easily form a lecture class, such as a group of users that attend a specific lecture.

Group data 63, which is correlated with the group ID of the group member data 62, includes a group ID and a group name, and audience permissions data 64, which is correlated with the group ID of the group data 63, includes a group ID and the ID of lecture data formed by each group of content. Thee group data 63 and the permissions data 64 are set by the management client (manager) 4, so that a lecture for which the user group obtains the audience permissions, i.e., the browsing permissions, is designated.

Lecture data 65, which is correlated with the lecture ID of the audience permissions data 64, includes a lecture ID and a lecture name, and video data 66, which is correlated with the lecture ID of the lecture data 65, includes a content ID and a lecture ID. The lecture data 65 and the video data 66 are set by the management client (manager) 4, so that video data corresponding to a lecture can be designated.

Slide data 67, which are correlated with the content ID of the video data 66, include a slide ID and a content ID. The slide data 67 is set by the management client (manager) 4, so that slide data corresponding to the video data can be designated.

The video data and the slide data correlated with each other (further, required meta-data, such as a content name) form a group of content to be distributed. The actual data of the video data and the slide data, may be correlated with the content ID and the slide ID, and may be stored and managed in a storage area other than the database 11 or another database.

The actual data, such as the video data and the slide data, can be edited by the editing client 3 of a user (lecturer) who receives the editing permission. When the lecturer employs the editing client 3 connected to the distribution server 1 to add, change or delete the video data or the slide data, the editing unit 32 reflects the instruction by the lecturer to the database 11.

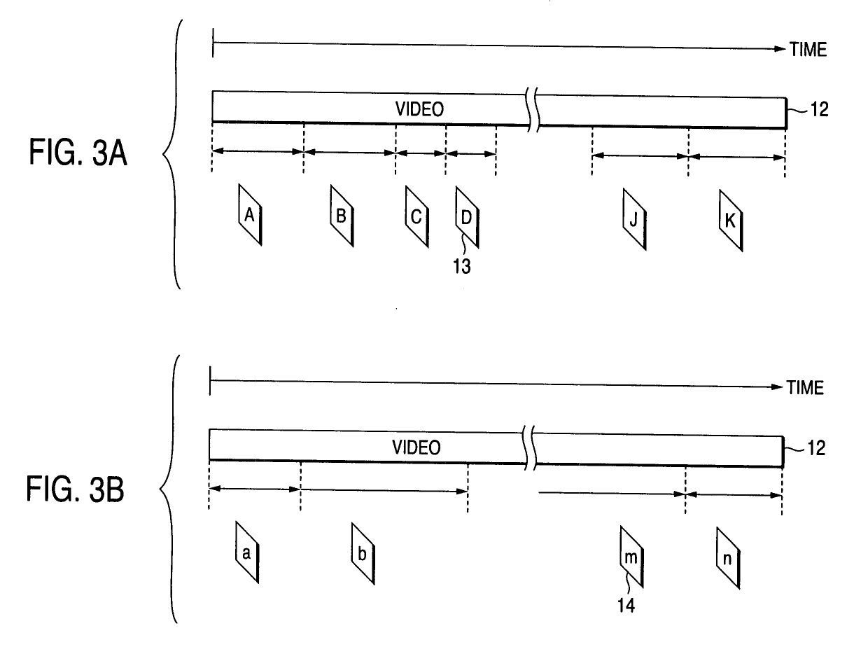

The video data and the slide data constituting the content are correlated with each other as is shown in FIGS. 3A and 3B, and are synchronously reproduced by the browsing client 2.

The correlation between the video data (actual data) 12 and the slide data 13 is shown in FIG. 3A, and the correlation between the video data 12 and the representative frame data 14 is shown in FIG. 3B.

In the content for the embodiment, the representative frame data 7 is also correlated with the video data 12, and is synchronously reproduced, so that the representative frame data 7 can be used as an index for the video data 12. The representative frame data 7 is a still picture for a scene specifically representing the situation that is extracted from the video data 12 and has a specific time span. The representative frame data 7 is correlated with a pertinent situation in the video data.

The slide data 13, which represents reference material cited for a video lecture, is a still picture that the lecturer who controls the editing client 3 correlates with an arbitrary reproduction time position in the video data 12. In accordance with the contents of the lecture, the lecturer sets up required slide data sets in correlation with the required reproduction time positions in the video data 12.

Therefore, as will be described later, when the browsing client 2 receives content that includes the video data 12, the slide data 13 and the representative frame data 7, the browsing client 2 reproduces and displays the video images on the display device 12, and also, at predetermined times, synchronously reproduces and displays the slide images and the representative frame images.

As is shown in FIG. 2, editing permissions data 68, which is correlated with the lecture ID of the lecture data 65 and the user ID of the user data 61, includes a user ID and a lecture ID. The editing permissions data 68 is set by the management client (manager) 4, so that, for each lecture (group of content), a user (lecturer) having editing permissions is designated for editing the content.

In the embodiment, the opening of a lecture and the setup for a user are performed when the management client 4 of the manager accesses the distribution server 1, and the editing of the actual data for the content that constitute the lecture is performed when the editing client 3 of the lecturer accesses the distribution server 1.

Access log data 69, which is correlated with the user ID for the user data 61 and the content ID for the video data 66, includes a user ID, a contents ID and viewing percentage data. The user ID and the contents ID are set by the management client (manager) 4, and as viewing percentage data, a value obtained by the viewing percentage counter 22 is transmitted by the browsing client 2.

The viewing percentage data represents how much of the video content received from the browsing client 2 the users have browsed on the screen. Based on the viewing percentage data, the status wherein the user has currently browsed the contents is managed.

In the embodiment, each time the browsing client 2 displays received content on the screen, the viewing percentage counter 22 measures the reproduction start position and the reproduction end position of the video, and obtains the viewing percentage by calculating a percentage for the time period extending from the reproduction start position to the reproduction end position and the total time period required for the reproduction of the video. Further, in this embodiment, when the reproduction start position and the reproduction end position for the video are held by the viewing percentage counter 22 and the current reproduction end position has advanced along the time axis from the preceding reproduction end position, the value is transmitted to the distribution server 1, which then updates the viewing percentage.

Since the viewing percentage need only represent, overall, how much of the video data has been browsed, as described in the embodiment, various methods can be employed for the measurement of the reproduction start and end positions and the calculation of the viewing percentage.

Notational data 70, which is correlated with the user ID of the user data 61 and the slide ID of the slide data 67, includes a user ID, a slide ID and text data that is entered as a note by the browsing client 2. The user ID and the slide ID are set by the management client (manager) 4, while the text data for the note is entered and transmitted by the browsing client 2.

As will be described later, the user can make and enter the notational data 70 by using the browsing client 2, while displaying the slide image, and in correlation with the slide image, corresponding notational data entered by each user can be stored and managed by the distribution server 1.

BBS data 71, which is correlated with the user ID of the user data 61 and the slide ID of the slide data 67, includes a user ID, a slide ID and text data that is entered as a remark or an inquiry by the browsing client 2. The user ID and the slide ID are set by the management client (manager) 4, and the BBS text data is entered and transmitted by the browsing client 2.

As will be described later, a user can employ the browsing client 2 to prepare and enter the BBS data 71 in correlation with the slide image, and in correlation with the slide image, corresponding BBS data 71 for each user can be stored and managed by the distribution server 1.

In the embodiment, the BBS data 71 contains a “Q flag” and a “A flag” (hereinafter, the both flags are generally referred to as “QA flag”). When a question is entered to the browsing client 2 by the browse user, the distribution server 1 retains and manages the question with the Q flag on. When an answer to a question of another user is entered to the browsing client 2 by the browse user, the distribution server 1 retains and manages the answer with the A flag on.

Therefore, a description couple of a question and its answer can be extracted from the BBS description using the QA flag.

As is described above, since the management client (manager) 4 accesses the distribution server 1 and sets various data in the database 11, a user can access the distribution server 1 by using the browsing client 2, and can receive the content data for which the user owns the browsing permissions. Further, since the status when the content has been browsed by the browsing client 2 is managed by the distribution server 1, the viewing percentage can be transmitted to the management client 4 and can be employed by the manager for user management. In addition, the lecturer can access the distribution server 1 using the editing client 3 and edit the contents data for which the lecturer owns the editing permissions.

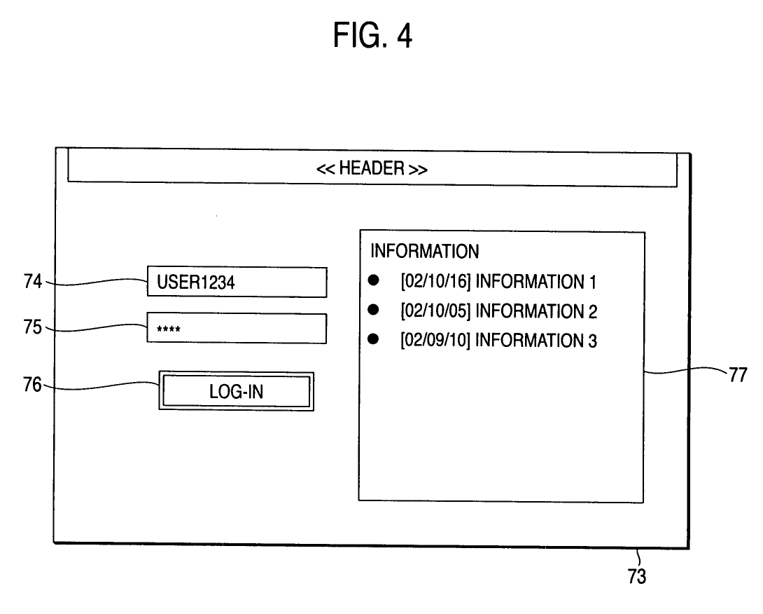

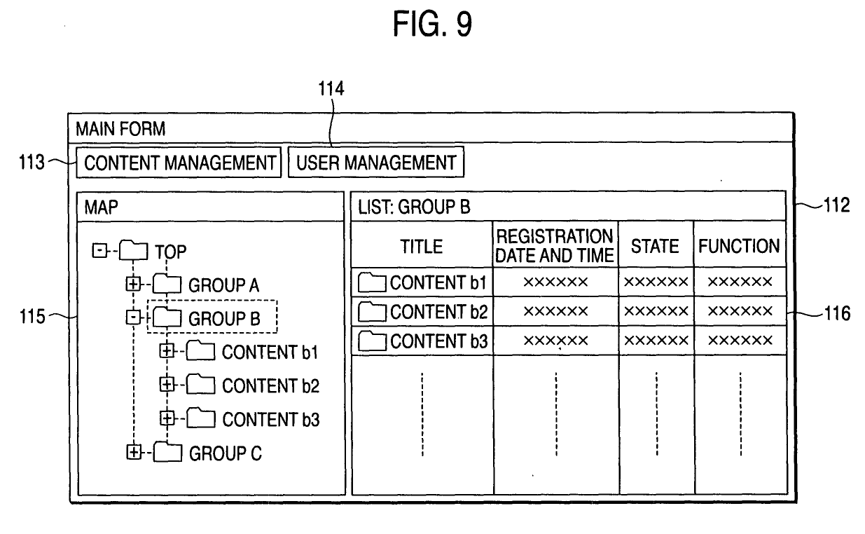

The individual operations and functions of the video browsing system in this embodiment will now be described while referring to example screen displays provided by the browsing client 2 in FIGS. 4 to 8 and example screen displays provided by the management client 4 in FIGS. 9 to 14.

It should be noted that of the functions of the management client 4, the editing client 3 does not have the functions for the registration of users, the setting up of the browsing screen and the setting up of the editing permissions, but does have the same functions as those of the management client 4 for content for which the editing client 3 owns the editing permissions, i.e., the lecture data for which the lecturer is responsible.

First, when the user employs the browsing client 2 to access the distribution server 1, the login page 73 shown in FIG. 4 is displayed on the display screen 21 of the browsing client 2. The login page 73 includes an entry 74 for inputting a user ID, an entry 85 for inputting a user password, a button 76 for inputting a login command and an information column 77 for displaying information that is registered by the manager, using the management client 4, in the database 11 of the distribution server 1.

When the user has entered the user ID and the password and clicked the login button 76 (by clicking a button of a input device such as a mouse connected to the management client 4 with a mouse pointer pointed over the login button 76 on the screen), the user ID and the password are transmitted to the distribution server 1, which then compares them with the user ID and the password designated in the user data 61.

When as a result of the comparison a user is authenticated as a registered user, the distribution server 1 examines the audience permissions data 64, and transmits to the browsing client 2 content list data for all the content for which the browsing permissions are provided for the pertinent user.

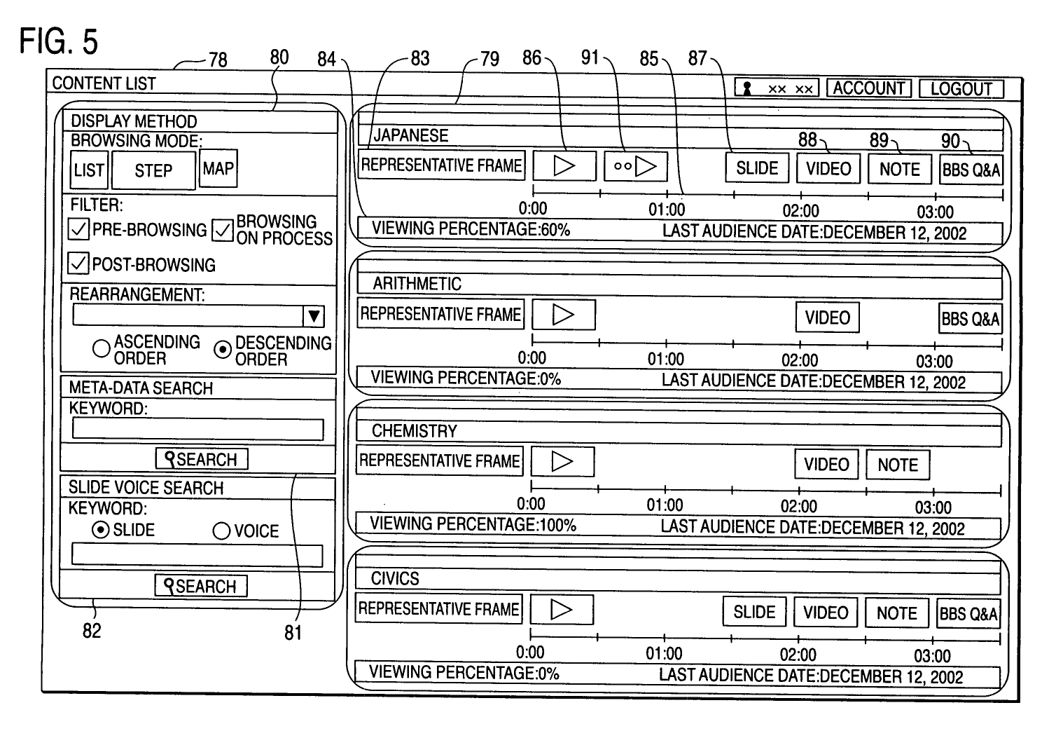

Then, the content list page 78 shown in FIG. 5 is displayed on the display screen 21 of the browsing client 2.

The content list page 78 includes: an operation area 79 for each group of content; an operation area 80 for selecting a method for displaying the content list; a meta-data search operation area 81 for searching for contents; and a slide, voice search operation area 82.

Located in the operation area 80 are: a button for selecting a form, such as a hierarchical form or a map form, for displaying the list; a filter condition setup portion for, based on the viewing percentage for each group of content, selecting content on the list in accordance with a specific condition, such as a pre-browsing, browsing or post-browsing process; and a rearrangement condition setup portion for employing the last audience date for each group of content to rearrange the list content condition, such as in the ascending order or in the descending order.

In the meta-data search operation area 81, there is an entry for inputting a keyword to be used for a content search based on meta-data, such as a content title or a content creator that is attached to each group of content.

In the slide, voice search operation area 82, there is an entry for the input of a keyword used to search for content based on text data that is correlated with the slide data.

For the registration of content data in the distribution server 1, the meta-data and the voice search keyword are registered in correlation with each group of content.

Included in the operation area 79 for each group of content are: an area 83 for displaying the content title set for the meta-data, and also for displaying a representative frame that is correlated with the video data of the content; an area 84 for displaying the viewing percentage and the last audience date for the video data; a gauge 85 for indicating the reproduction time position for the video data; a button 86 for instructing the reproduction start for the video data; a button 87 for instructing the display of the slide list for the content; a button 88 for instructing the display of detailed information for the video data; a button 89 for instructing the display of notes written in correlation with the slide data of the content; and a button 90 for displaying the BBS data that are prepared in correlation with the content or the Q&A data extracted from the BBS data, or for entering BBS data or Q&A data.

In the embodiment, a button 91 for starting the reproduction of the video data at the time position while there is an audience for the content that currently is being performed is provided for the operation area 79, except for content for which the viewing percentage is 0% or 100%. When the user points at the reproduction resume button 91 for content for which the viewing percentage is 60%, the browsing client 2 employs the reproduction end position held by the viewing percentage counter 22, and reproduces the received video data at the time position to which 60% of the video data has been forwarded from the first position.

Therefore, when a user points at the reproduction resume button 91, the user can skip the portion of the video data that has already been browsed and start the reproduction by beginning with the portion that has not yet been browsed.

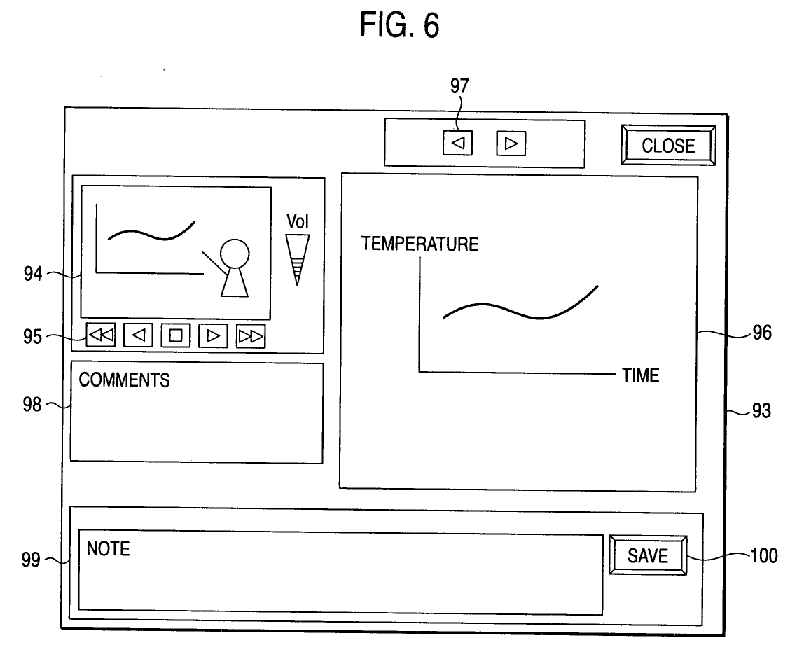

When a user points at the reproduction start button 86 or the reproduction resume button 91, the request for the distribution of the content is transmitted to the distribution server 1, which in turn distributes the requested content. As a result, the content browsing page 93 shown in FIG. 6 is displayed on the display screen 21.

The content browsing page 93 includes: an area 94 for reproducing and displaying the video data in the content; a button 95 for instructing the starting or the halting of the video reproduction; an area 96 for reproducing and displaying the slide data in the content in synchronization with the video reproduction; a button 97 for instructing the forward or reverse feeding of the slide image; an area 98 for displaying a comment attached by a lecturer to the video data; an area 99 wherein a user operates the browsing client 2 to enter a note; and a save button 100 for transmitting the notational data to the distribution server 1 and for saving the notational data.

Since the video data and the slide data are correlated with each other, as is shown in FIG. 3, the slide image is sequentially changed on the display in synchronization with the reproduction of the video data. When the slide images to be displayed are switched by pointing at the button 97, the reproduction time position for the video data to be displayed is also changed to a position corresponding to the slide image after the switch.

Further, since each slide image and a note are correlated with each other, as is shown in FIG. 2, the note in the area 99 is changed as the slide images are switched. Therefore, a user can enter a note in correlation with the slide image, and can display the slide image on the screen in correlation with the note, or the note in correlation with the slide image.

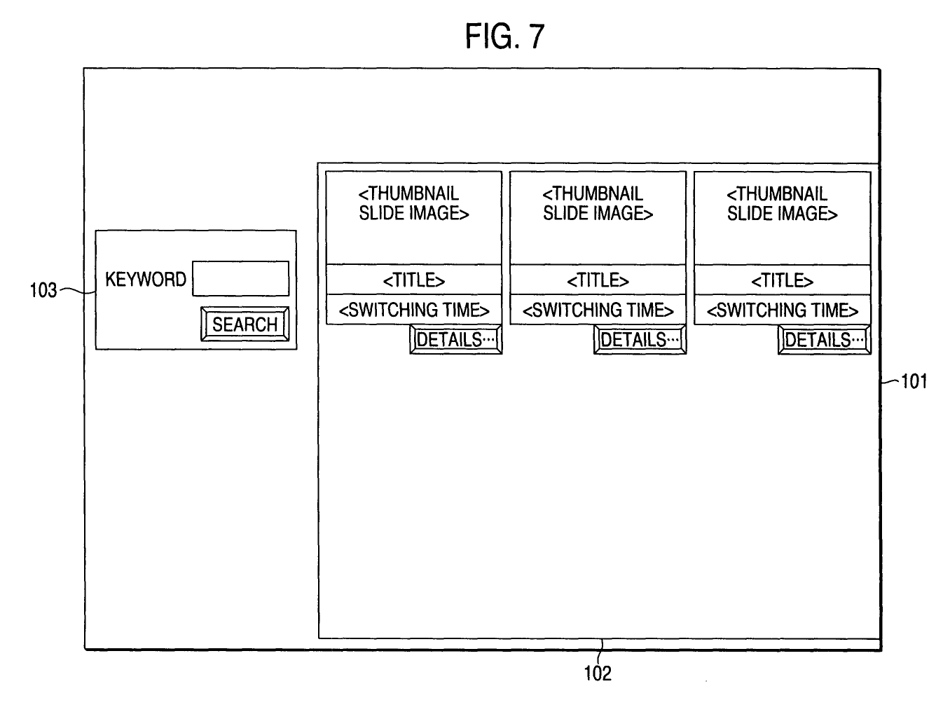

When the slide button 87 is clicked, a request for the slide distribution of the content is transmitted to the distribution server 1, which then transmits to the browsing client 2 a list of the slide data for the pertinent content. As a result, the slide list page 101 shown in FIG. 7 is displayed on the display screen 21.

The slide list page 101 includes: an area 102 for displaying, as thumbnail images, all the slide images included in the content; and an area 103 for entering a keyword that is used to perform a content search based on meta-data, such as a title, attached to the slide image. On this page 101, the user can easily find a desired slide image, and further, when the user points at the slide image, the video data can be reproduced and displayed at a corresponding time position.

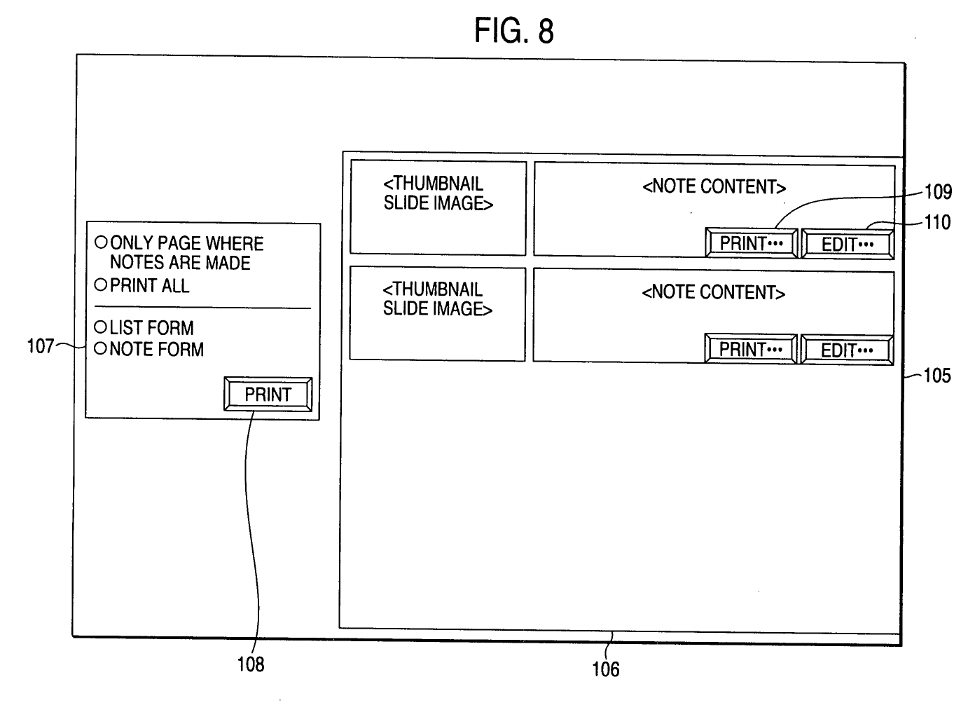

When the note button 89 is clicked, a request for the note distribution for the content is transmitted to the distribution server 1, which then transmits to the browsing client 2 the note list for the content. As a result, the note list page 105 shown in FIG. 8 is displayed on the display screen 21.

The note list page 105 includes: an area 106 for displaying the content of a note together with a thumbnail slide image; and an area 107, including a button 108 for printing a list for a designated print form. On this page 105, a user can display, in correlation with the slide image, or print a note entered by the user.

Further, a print button 109 and an edit button 110 are provided for each included note on the note list page 105, and either a note can be printed by pointing at the print button 109, or the contents of the note can be edited by pointing at the edit button 110. In the case above, the content of the edited note is transmitted to the distribution server 1, and is used to update the note, which is stored in the distribution server 1.

When the manager accesses the distribution server 1 by using the management client 4, the login page shown in FIG. 4 is displayed on the display screen 41 of the management client 4. And when the manager enters a user ID and password on the login page and points at the login button, the user ID and the password are transmitted to the distribution server 1, which then compares the user ID and the password with those included in the user data 61. It should be noted that, although not shown in FIG. 2, the user IDs and the passwords for users having the manager permissions are registered in the database 11.

When through a comparison a manager is authenticated as a registered manager, in accordance with an access by the management client 4, the distribution server 1 transmits to the management client 4 the data stored in the database 11 and also employs the data received from the management client 4 to update corresponding data stored in the database 11.

When the login is completed in this manner, a main form page 112 in FIG. 9, which includes a content management button 113 and a user management button 114, is displayed on the display screen 41 of the management client 4.

FIG. 9 is a diagram showing the state wherein the content management button 113 is clicked on the main form page 112. A status management unit 43 is activated by pointing at the content management button 113, and all the content files registered in the database 11 of the distribution server 1 are displayed as a map form in a map display area 115. Further, all the content files (content titled content b1, b2, . . . in FIG. 9), which are included in a content file (content titled category B in FIG. 9), that are clicked in the map area 115 are displayed as a list form in a list display area 116.

Furthermore, in the list display area 116, not only the titles for the content, but also registration dates, status information, concerning whether browsing by a user is enabled, and function information, concerning whether the functions for handling the note data and the BBS data are provided, are displayed, so that the manager can obtain and manage the current status of the contents.

It should be noted that, since the editing client 3 can display the same information on the screen, the lecturer can confirm the current status of the content for which the lecturer is responsible.

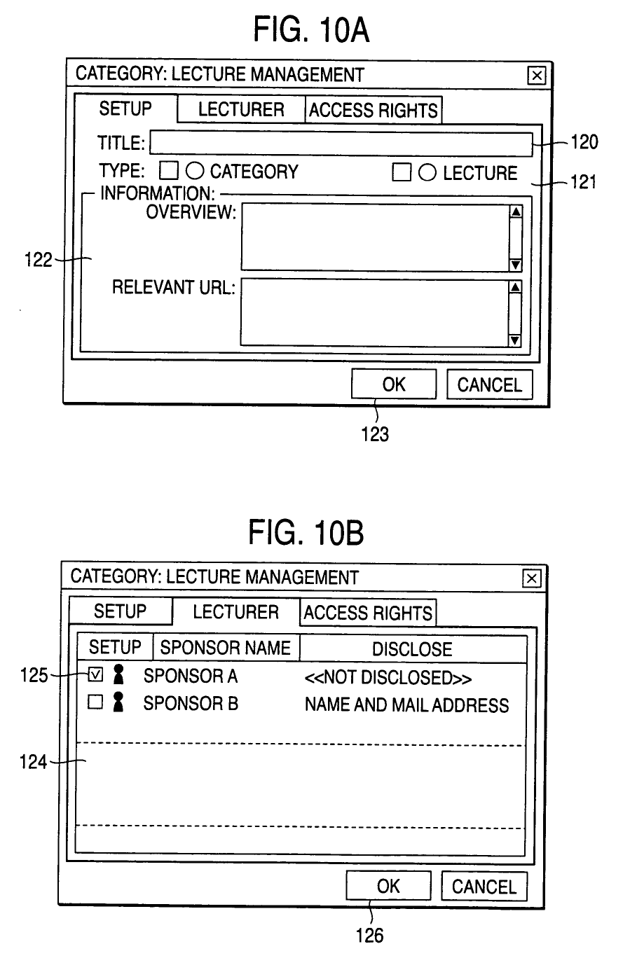

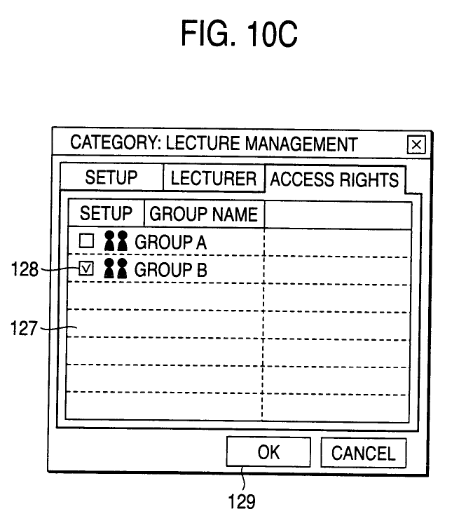

Together with the information in FIG. 9, one of the node management dialogue windows shown in FIGS. 10A to 10C is displayed on the screen 41. The manager can employ these dialogue windows to set up each node (the unit category shown in FIG. 9) for the database 11 of the distribution server 1.

The dialogue window in FIG. 10A is used to set a node (category), and includes an entry 120 for inputting the title of a node; an operation area 121 for designating the node type, representing a category shown in FIG. 9 or the lecture contents included in the category; and an entry 122 for inputting an overview for the node and a relevant URL.

When the manager enters necessary data for the node management dialogue window (setup) and points at an OK button 123, the setup unit 42 is activated and transmits the setup content to the distribution server 1. Thus, a new node can be set for the lecture data 65 in the database 11.

The dialogue window shown in FIG. 10B is used to set a lecturer for a node, and an entry 124 is provided for displaying a list of lecturer choices.

Check boxes 125 are provided for the individual lecturers, and when a manager points at one of the check boxes 125 and at an OK button 126 for a desired lecturer to be designated for the node, the setup unit 42 is activated and transmits the setup content to the distribution server 1. Thus, the selected lecturer can be set in the editing permissions data 68 in the database 11.

A dialogue window in FIG. 10C is used to set a user for a node, and an entry 127 is provided for displaying a list of user group choices. In this embodiment, a plurality of users are grouped in advance, and the browsing permissions for a node are set for each user group. However, the browsing permissions may be set for each user, instead of a group of users being formed.

Check boxes 128 are provided for the individual choices, and when a manager points at one of the check boxes 128 and at an OK button 129, to make a choice to permit node browsing, the setup unit 42 is activated and the setup content is transmitted to the distribution server 1. Then, the choice can be set as a user group in the audience permissions data 64 in the database 11.

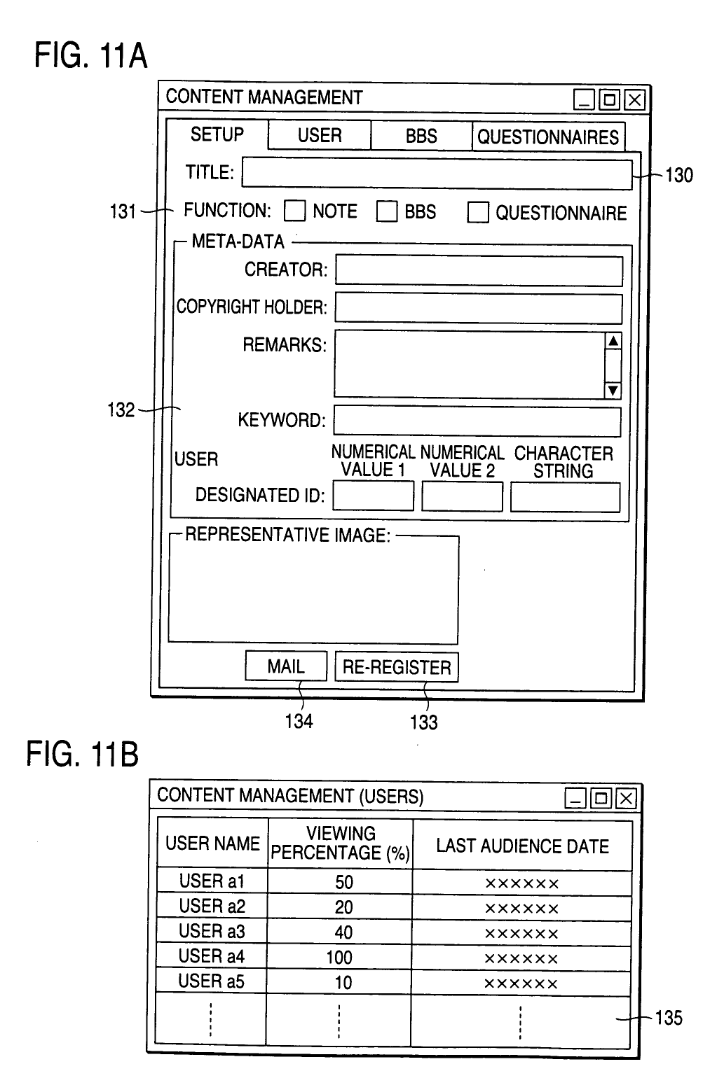

The content management dialogue windows in FIGS. 11A and 11B are displayed on the screen 41. By using these dialogue windows, the manager can set each node (the unit of content shown in FIG. 9) in the database 11 of the distribution server 1, and can obtain data from the distribution server 1 and display the data on the screen.

The dialogue window in FIG. 11A is used to set content, and includes: an entry 130 for inputting the content title; an operation area 131 for designating functions for handing the notational data, the BBS data and questionnaires; and an area 132 for inputting meta-data, such as data for a content creator.

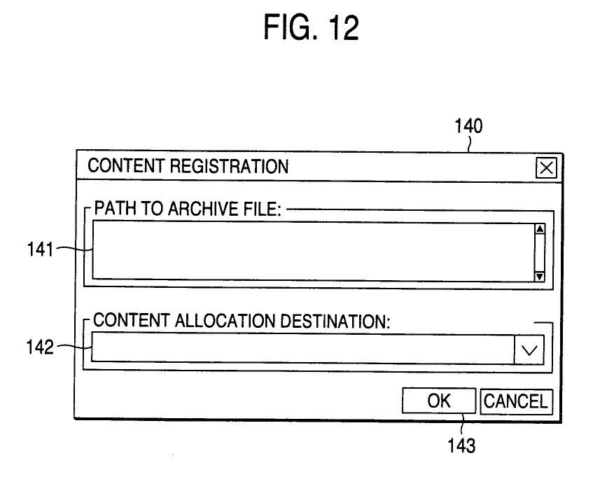

When a manager enters necessary data for the content management dialogue window and points at a registration button 133, the setup unit 42 is activated, the content registration dialogue window 140 in FIG. 12 is displayed on the screen 41, and the setup content is transmitted to the distribution server 1. Thus, the distribution server 1 can register new content in the database 11, or can update the current content.

A mail button 134 is used to activate a mail unit 44, as will be described later.

Further, since the above described operations can also be performed by the editing unit 32 of the editing client 3, a lecturer can add to, or delete or change content included in the category.

The dialogue window shown in FIG. 11B is used to display the user viewing percentage for specific content, and includes an area 135 for displaying a status list for each user in a user group for which the browsing permissions for the content has been set.

When the status management unit 43 of the management client 4 obtains the user data 61 and the access log data 69 from the distribution server 1, the user names, the viewing percentage and the last audience date are displayed in the list display area 135. Thus, the manager can identify how much of the content each user has browsed and the last day the user browsed the content.

The content registration dialogue window 140 in FIG. 12 is used for registering in the database 11, as the video data 66 and the slide data 67, a content file that is collected as the archive file 5. An entry 141, for inputting an archive file path, and an entry 142, for inputting a content allocation position, are provided for the content registration dialogue window 140.

When the manager (lecture) enters necessary information in the content management dialogue window 140, and points at an OK button 143, the setup unit 42 is activated and transmits the setup content and the archive file 5 to the distribution server 1. Then, the distribution server 1 can register new content in the database 11, or can update the present content. It should be noted that the content can be deleted by erasing a file path and outputting the content as the archive file 5.

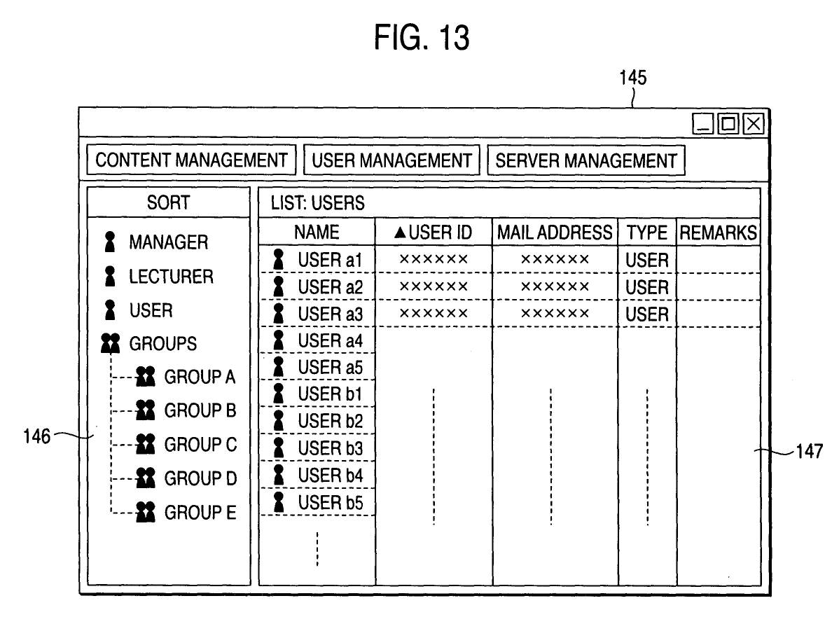

When the user management tab is clicked on the main form page 112 in FIG. 9, the user management page 145 shown in FIG. 13 is displayed on the screen 41. By using this page 145, a manager can set a registered user as a manager choice or a lecturer choice, or can group registered users.

The user management page 145 includes: an area 146 for displaying a manager, a lecturer and user groups; and an area 147 for displaying a list of all the registered users. When the status management unit 43 of the management client 4 obtains all the registered user group names from the distribution server 1, these names are displayed in the user group area 146, and the user names, the user IDs, the mail addresses and the types of all the users are displayed in the list display area 147.

Then, when the manager points at and designates one of the users in the list display area 147 as either a manager, a lecturer or a member of a user group displayed in the group area 146, the pertinent user can be set as a manager choice, as a lecturer choice or as one member of the user group.

Therefore, the manager can employ the setup unit 42 of the management client 4 to designate a desired user as a manager choice, a lecturer choice or a member of an arbitrary user group. And as described above, for each group of content (category), the editing permissions and browsing permissions can be assigned to the manager, the lecturer and the user group.

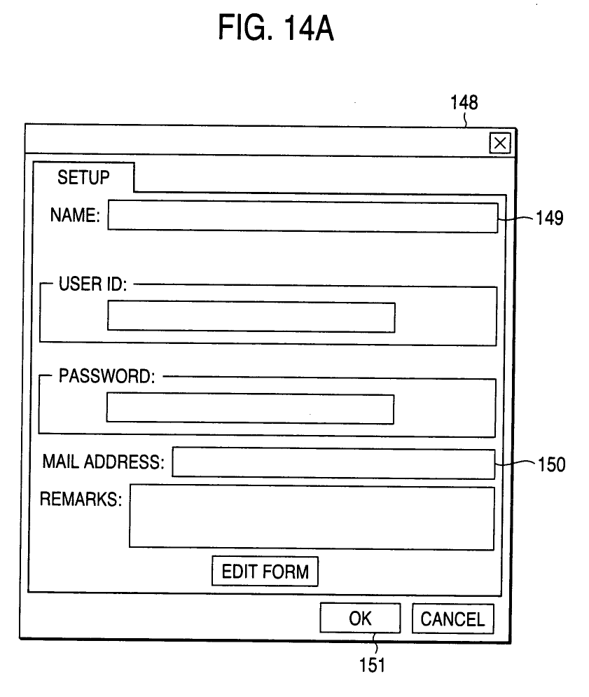

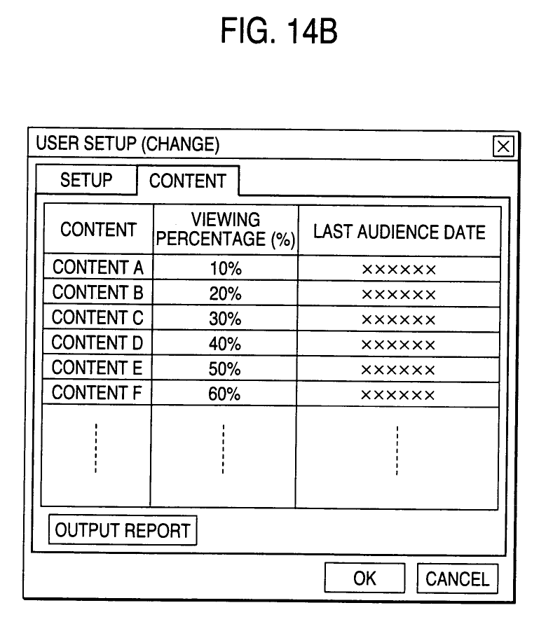

A new user can be registered for the video browsing system by displaying on the screen 41 the user setup dialogue window 148 in FIGS. 14A and 14B. The user setup dialogue window 148 includes an entry 149 for inputting a user name and an entry 150 for inputting a mail address, so that the manager can register user data in the video browsing system.

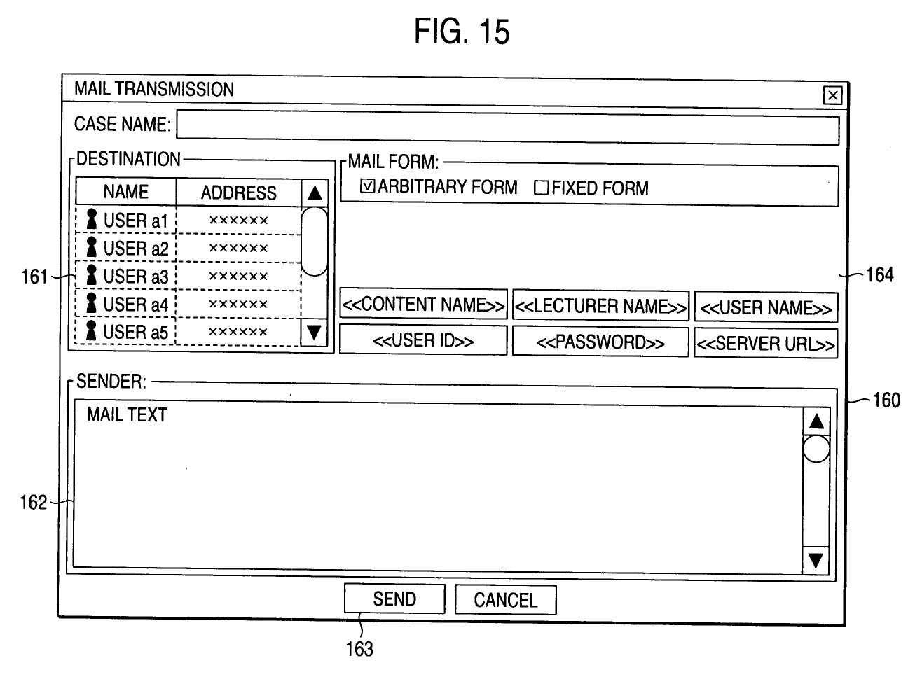

When a manager enters necessary data for the user setup dialogue window 148 and points at an OK button 151, the setup unit 42 is activated and transmits the setup content to the distribution server 1. Thus, the distribution server 1 can register a new user in the user data 61 in the database 11. It should be noted that the ID and the password of this new user are automatically generated by the setup unit 42, are transmitted to the distribution server 1 and are registered in the user data 61 in the database 11. Further, an email including the user ID and the password is transmitted to the user by the manager using the mail unit 44 in FIG. 15.

When the manager points at the mail button 134 on the content management dialogue window in FIG. 11A, the mail unit 44 is activated, and the mail transmission dialogue window 160 shown in FIG. 15 is displayed on the screen 41. It should be noted that the editing client 3 has the same function for the content for which the editing permissions are obtained.

The mail transmission dialogue window 160 includes: an area 161 for displaying address information; and an area 162 for entering the mail text. The names of users for which the browsing permissions for the content is provided and a list of mail addresses is automatically displayed in the address information area 161.

Therefore, when a manager enters mail text in the area 162 by using the keyboard of the management client 4 and points at a send button 163, the manger can transmit an e-mail to all the users displayed in the address information area 161, and can easily contact users concerning the individual content.

In the case above, since the mail unit 44 can support creation of an email, the manager need only point at a retrieval button 164 to automatically enter, in the area 162, the name of the content and the name of the lecturer designated in the content.

Furthermore, since the mail unit 44 can also support the address selection, the manager can delete arbitrary user information from the address information area 161 to erase a user from the mail destinations. Further, by using the address selection support provided by the mail unit 44, the users displayed in the address information area 161 can be sorted in the ascending order or the descending order based on the viewing percentages. Further, an email can be transmitted only to users for whom a specific viewing percentage or higher is obtained.

Therefore, to users for whom the viewing percentage is low, an email can be easily transmitted to request the content be browsed, and content management can be employed to encourage users to browse the content.

As is described above, according to the present invention, to provide for users a service for distributing content that includes video data and synchronous slide data, the content access permissions are designated for users and is managed. With the arrangement, system operation consonant with a purpose can be implemented, e.g., an actual education situation, wherein a lecturer gives a lecture to a user group, can be provided by using a network technique.

In the embodiment above described, the distribution and the management of the content is provided by separate clients and server. However, the distribution of the content and the management of the extent information may be provided by a single computer (e.g. the distribution server 1).

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A video browsing system comprising:
a distribution server configured to store and distribute content including video data and slide data reproduced in synchronization with the video data;
a browsing client configured to receive the content, to reproduce and display the video data on a screen thereof, and to synchronously display the slide data; and
a provider client belongs to a content provider and having a permission to edit the content,
wherein the distribution server comprises a manage unit configured to manage a permission for browsing each of a plurality of content and a permission for editing the content, and
wherein, the manage unit allows to distribute the content in accordance with an access of the browsing client of a user having the permission for browsing the content, and allows to edit the content in accordance with an access of the provider client.

2. The video browsing system as claimed in claim 1 further comprising an administrator client having a permission of an administrator,
wherein the manage unit sets the permission for browsing and the permission for editing in accordance with an access of the administrator client.

3. The video browsing system as claimed in claim 1, wherein the distribution server further comprises a storing unit configured to store notational data, which the user has entered into the browsing client in accordance with the slide data displayed on the screen, in association with the user and the slide data, and
wherein the distribution server provides the notational data to the browsing client in accordance with a request from the browsing client of a user.

4. A distribution server comprising:
a distribution unit configured to distribute content including video data and slide data reproduced in synchronization with the video data; and
a manage unit configured to manage a permission for browsing each of a plurality of content and a permission for editing the content,
wherein the manage unit allows to distribute the content in accordance with an access of the browsing client of a user having the permission for browsing the content, and allows to edit the content in accordance with an access of the provider client.

5. A manage client for managing a video browsing system including: a distribution server configured to store and distribute content including video data and slide data reproduced in synchronization with the video data; a browsing client configured to receive the content, to reproduce and display the video data on a screen thereof, and to synchronously display the slide data; and a provider client belongs to a content provider and having a permission for editing the content, the manage client comprising:
a manage unit configured to configure a permission for browsing the content, wherein in accordance with an access of the browsing client of a user having the permission for browsing the content, allows to distribute the content; and to configure a permission for editing the content, wherein in accordance with an access of the provider client having the permission for editing the content, allows to edit the content.

6. A computer program product for controlling a distribution server, which distributes content including video data and slide data reproduced in synchronization with the video data to a browsing client that reproduces and displays the content on a screen thereof, the program product comprising:
means for managing a permission for browsing each of a plurality of content and a permission for editing the content;
means for distributing the content in accordance with an access of the browsing client of a user having the permission for browsing the content; and
means for allowing to edit the content in accordance with an access of the user having the permission for editing the content.

7. A computer program product for controlling a manage client, which manages a video browsing system including: a distribution server configured to store and distribute content including video data and slide data reproduced in synchronization with the video data; a browsing client configured to receive the content, to reproduce and display the video data on a screen thereof, and to synchronously display the slide data; and a provider client belongs to a content provider and having a permission to edit the content, the program product comprising:
means for configuring a permission for browsing, wherein in accordance with an access of the browsing client of a user having the permission for browsing the content, allows to distribute the content; and for configuring the permission for editing the content, wherein in accordance with an access of the provider having the permission for editing the content, allows to edit the content.

8. A video browsing method for a distribution server configured to store and distribute content including video data and slide data reproduced in synchronization with the video data, the method comprising:
managing, for each of the content, a permission for browsing the content and a permission for editing the content;
distributing the content in accordance with an access of the browsing client of a user having the permission for browsing the content;
allowing to edit the content in accordance with an access of a provider of the content having the permission for editing the content;
storing notational data, which the user has entered into the browsing client in accordance with the slide data displayed on the screen, in association with the user and the slide data; and
providing the stored notational data in accordance with a request from a user.
